(19) United States
(12) Patent Application Publication
(10) Pub. No.: US 2026/0197433 A1
(43) Pub. Date: Jul. 9, 2026

(54) ELECTRONIC APPARATUS AND STEREOSCOPIC IMAGE DISPLAY METHOD THEREOF

(71) Applicant: Acer Incorporated, New Taipei City (TW)

(72) Inventors: Pei-Yang Tsai, New Taipei City (TW); Sergio Cantero Clares, New Taipei City (TW); Chi-Kang Lee, New Taipei City (TW)

(73) Assignee: Acer Incorporated, New Taipei City (TW)

(21) Appl. No.: 19/014,250

(22) Filed: Jan. 9, 2025

(51) Int. Cl. H04N 13/398; H04N 13/00; H04N 13/15; H04N 13/156; H04N 13/183

(52) U.S. Cl. CPC H04N 13/398; H04N 13/15; H04N 13/156; H04N 13/183; H04N 2013/0092

(57) ABSTRACT

An electronic apparatus and a stereoscopic image display method thereof are disclosed. The method is adapted to the electronic device including a stereoscopic display and includes the following steps. A display frame including a stream image is obtained. By executing edge detection and line detection, at least one rectangular image region in the display frame is captured. A watermark detection on at least one rectangular image region is performed. In response to a watermark appearing in one of the at least one rectangular image region, a stereoscopic format image is generated based on the display frame and one of the at least one rectangular image region. The stereoscopic display is controlled to operate in a stereoscopic display mode to display the stereoscopic format image, so that image content of the stream image to be displayed with a stereoscopic visual effect.

### BACKGROUND

### Technical Field

The disclosure relates to an image processing technology, and particularly to an electronic apparatus and its stereoscopic image display method.

### Related Art

With the advancement of display technology, stereoscopic displays supporting stereoscopic visual technology have gradually become widespread. Stereoscopic visual technology allows viewers to perceive the stereoscopic sense in image scenes, such as the stereoscopic facial features of characters and depth of field, which traditional 2D images cannot present. The principle of stereoscopic visual technology is to let the viewer's left eye view the left eye image and the viewer's right eye view the right eye image, enabling the viewer to experience a 3D visual effect. 3D displays can provide left eye images and right eye images separately to the viewer's left and right eyes, offering people a visually immersive experience. It is known that for image content in specific 3D image formats, 3D displays need to adopt corresponding 3D display technologies for playback to achieve display results that allow viewers to perceive 3D visual effects. In other words, if a 3D display cannot correctly identify the 3D image format of the image content, the 3D display will not be able to smoothly provide display results with 3D visual effects.

### SUMMARY

The disclosure provides an electronic apparatus and stereoscopic image display method that may effectively solve the aforementioned problems.

An exemplary embodiment of the disclosure provides a stereoscopic image display method, which is adapted to an electronic apparatus including a stereoscopic display and includes the following steps. A display frame including a streaming image is obtained. At least one rectangular image region in the display frame is extracted by executing edge detection and straight line detection. A watermark detection is executed on the at least one rectangular image region. In response to a watermark appearing in one of the at least one rectangular image region, a stereoscopic format image is generated according to the display frame and one of the at least one rectangular image region. The stereoscopic display is controlled to operate in a stereoscopic display mode to display the stereoscopic format image, so that the image content of the streaming image is presented with stereoscopic visual effects.

Another exemplary embodiment of the disclosure provides an electronic apparatus, which includes a transceiver, a stereoscopic display, and at least one processor. The transceiver is configured to receive a streaming image. The processor is coupled to the transceiver and the stereoscopic display, and is configured to execute the following operations. A display frame including a streaming image is obtained. At least one rectangular image region in the display frame is extracted by executing edge detection and straight line detection. A watermark detection is executed on the at least one rectangular image region. In response to a watermark appearing in one of the at least one rectangular image region, a stereoscopic format image is generated according to the display frame and one of the at least one rectangular image region. The stereoscopic display is controlled to operate in a stereoscopic display mode to display the stereoscopic format image, so that the image content of the streaming image is presented with stereoscopic visual effects.

Based on the above, in the embodiment of the disclosure, after obtaining the display frame including the streaming image, at least one rectangular image region in the display frame may be identified through edge detection and straight line detection. By executing watermark detection on the at least one rectangular image region, it may be determined whether each rectangular image region includes stereoscopic image content with embedded watermark. When a certain rectangular image region includes the stereoscopic image content with the embedded watermark, a stereoscopic format image including left eye image and right eye image may be generated according to the display frame and the certain rectangular image region. Based on this, by embedding watermark in the stereoscopic format image, it may accurately detect that the display frame includes the streaming image conforming to the stereoscopic image format, to control the stereoscopic display to automatically provide stereoscopic display function.

### BRIEF DESCRIPTION OF THE DRAWINGS

FIG. 1 is a schematic diagram of an electronic apparatus according to an embodiment of the disclosure.

FIG. 2 is a schematic diagram of a stereoscopic display according to an embodiment of the disclosure.

FIG. 3 is a flowchart of a stereoscopic image display method according to an embodiment of the disclosure.

FIG. 4 is a schematic diagram of embedded watermark according to an embodiment of the disclosure.

FIG. 5 is a flowchart of extracting at least one rectangular image region according to an embodiment of the disclosure.

FIG. 6 is a schematic diagram of extracting at least one rectangular image region according to an embodiment of the disclosure.

FIG. 7 is a flowchart of generating a stereoscopic format image according to an embodiment of the disclosure.

FIG. 8 is a schematic diagram of generating a stereoscopic format image and a weaving frame according to an embodiment of the disclosure.

FIG. 9 is a schematic diagram of a scenario where the image content of a streaming image is presented with stereoscopic visual effect according to an embodiment of the disclosure.

### DESCRIPTION OF THE EMBODIMENTS

Some exemplary embodiments of the disclosure will now be described in detail with reference to the accompanying drawings. The reference numerals used in the following description, when appearing in different drawings with the same reference numerals, will be considered as the same or similar components. These exemplary embodiments are only a part of the disclosure and do not reveal all possible embodiments of the disclosure. More precisely, these exemplary embodiments are merely examples of the methods and apparatus in the claims of the disclosure.

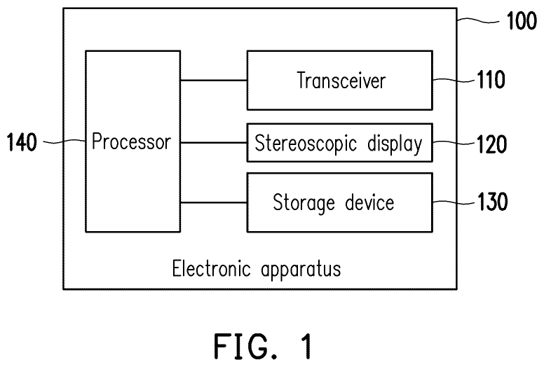

FIG. 1 is a schematic diagram of an electronic apparatus according to an embodiment of the disclosure. Referring to FIG. 1, the electronic apparatus 100 may be implemented as, for example, the following electronic apparatus with image processing and computing capabilities: a laptop computer, a tablet computer, a personal computer, a game console, a portable electronic apparatus, a desktop computer, or other electronic apparatus. The electronic apparatus 100 includes a transceiver 110, a stereoscopic display 120, a storage device 130, and at least one processor 140.

The transceiver 110 may transmit and receive signals wirelessly or via wired connections. The transceiver may also execute operations such as low-noise amplification, impedance matching, mixing, upward or downward frequency conversion, filtering, amplification, and similar operations. The electronic apparatus 100 may receive and send data through the transceiver 110, such as receiving streaming images of video streams and so on. In some embodiments, the electronic apparatus 100 may also include an antenna (not shown) for receiving wireless radio frequency signals.

The stereoscopic display 120 may allow users to experience stereoscopic visual effects. To enable users to perceive 3D visual effects through the stereoscopic display 120, the stereoscopic display 120 may, according to its hardware specifications and the applied 3D display technology, allow the user's left eye and right eye to view image content corresponding to different viewing angles (i.e., left eye image and right eye image) respectively. In some embodiments, the stereoscopic display 120 may be a glasses-free 3D display, for example, it may be implemented as a display for a laptop computer, a television, a desktop monitor, or an electronic signage, etc. In some embodiments, the left eye image and right eye image may be displayed simultaneously based on stereoscopic image display technology, such as parallax barrier technology, lens technology, or directional backlight technology.

From another perspective, the stereoscopic display 120 may include a Liquid Crystal Display (LCD), a Light-Emitting Diode (LED) display, an Organic Light-Emitting Diode (OLED) display, or other types of displays, but the disclosure is not limited thereto.

The storage device 130 is configured to temporarily or permanently store data, such as images, instructions, codes, software modules, and other data. Specifically, the storage device 130 may include volatile storage circuits. Volatile storage circuits are used to store data in a volatile manner. For example, volatile storage circuits may include random access memory (RAM) or similar volatile storage media. Alternatively, the storage device 130 may include non-volatile storage circuits. Non-volatile storage circuits are used to store data in a non-volatile manner. For example, non-volatile storage circuits may include read-only memory (ROM), solid-state drive (SSD), and/or traditional hard disk drive (HDD) or similar non-volatile storage media. The number of storage devices 130 may be one or more, and the disclosure does not impose any limitation in this regard.

The processor 140 is connected to the transceiver 110, the stereoscopic display 120, and the storage device 130, and is responsible for all or part of the operations of the electronic apparatus 100. For example, the processor 140 may include a central processing unit (CPU), a graphic processing unit (GPU), or other programmable general-purpose or special-purpose microprocessors, digital signal processor (DSP), programmable controllers, application-specific integrated circuit (ASIC), programmable logic device (PLD), or other similar devices or combinations of these devices. The number of processors 140 may be one or more, and the disclosure does not impose any limitation in this regard.

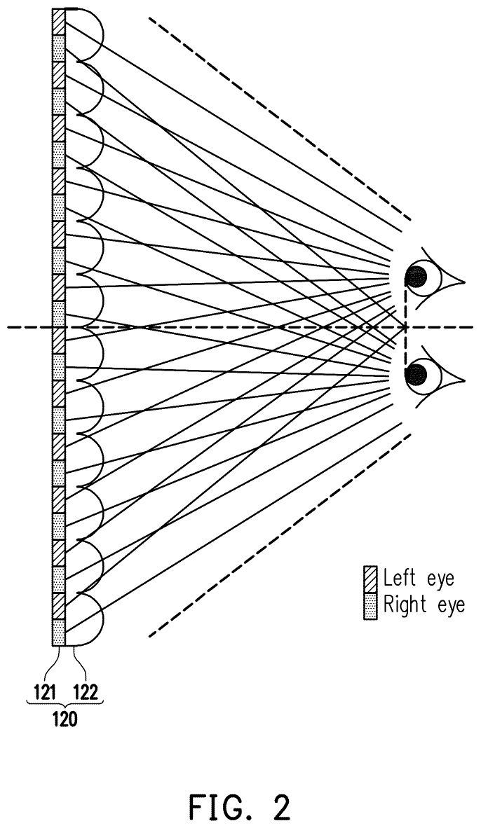

FIG. 2 is a schematic diagram of a stereoscopic display according to an embodiment of the disclosure. Referring to FIG. 2, in some embodiments, the stereoscopic display 120 may be a naked-eye stereoscopic display, which may provide different images for the left eye and right eye through lens refraction principle, allowing viewers to experience stereoscopic display effects. The stereoscopic display 120 may include a display panel 121 and a lens layer 122. The lens layer 122 is placed above the display panel 121, and viewers can see the content provided by the display panel 121 through the lens layer 122. The stereoscopic display 120 can place the pixels of the left eye image and the pixels of the right eye image in corresponding pixel positions on the display panel 121. The lens layer 122, through light refraction, refracts different display contents (i.e., left eye image and right eye image) to different positions in space, allowing the left eye and right eye to receive two different images with parallax respectively. It is known that in order to place the pixels of the left eye image and the pixels of the right eye image in the corresponding pixel positions on the display panel 121, the left eye image and the right eye image need to undergo image weaving processing to generate a weaving frame with alternating arrangement of pixels from the left eye image and the right eye image.

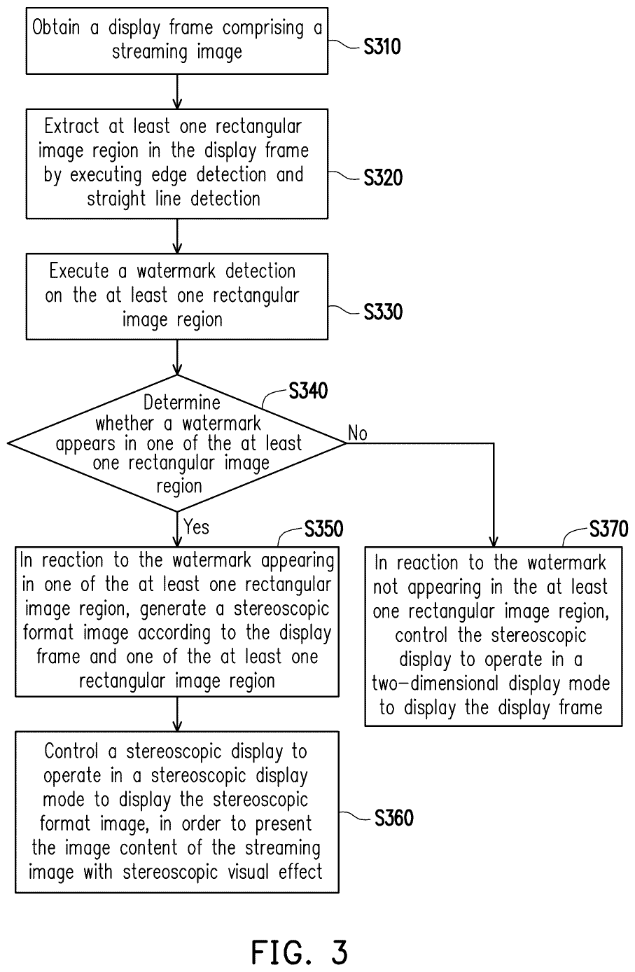

FIG. 3 is a flowchart of a stereoscopic image display method according to an embodiment of the disclosure. Referring to FIG. 3, the operation process of the embodiment is applicable to the electronic apparatus 100 in the above-mentioned embodiment. The following will explain the detailed steps of the embodiment in conjunction with the various components in the electronic apparatus 100.

In step S310, the processor 140 may obtain a display frame including a streaming image. Specifically, the processor 140 may receive a video stream including the streaming image through the transceiver 110. That is, the processor 140 may receive the streaming image through the transceiver 110 and generate a display frame including the streaming image. In some embodiments, the processor 140 may obtain the display frame including the streaming image using a screenshot function. In some embodiments, the aforementioned streaming image may originate from a video stream of a video conferencing application, a multimedia playback application, or a browser application. In some embodiments, when the processor 140 executes a video conferencing application, the processor 140 may receive streaming images provided by conference participants through the transceiver 110, and generate a display frame including the window operation interface of the video conferencing application and the streaming image.

In some embodiments, the processor 140 may extract the display frame through an application programming interface (API) provided by the operating system. For example, the processor 140 may use screen capture technologies such as the “Desktop Duplication API” or “DirectX Graphics Infrastructure (DXGI)” of the Windows operating system to obtain the display frame, but may not be limited to these.

In the embodiment of the disclosure, images conforming to the stereoscopic format may be embedded with watermarks to generate streaming images. The watermark may be an invisible watermark. Therefore, the processor 140 may determine whether the currently displayed streaming image conforms to the stereoscopic format or not based on the watermark detection result. The aforementioned stereoscopic format, for example, is a Side-by-Side (SBS) image format, but the disclosure is not limited thereto. The operation of embedding watermarks into stereoscopic format images may be achieved through post-processing of images conforming to the stereoscopic format. Alternatively, through specially designed stereoscopic image capture devices, these stereoscopic image capture devices may directly output stereoscopic format images with embedded watermarks.

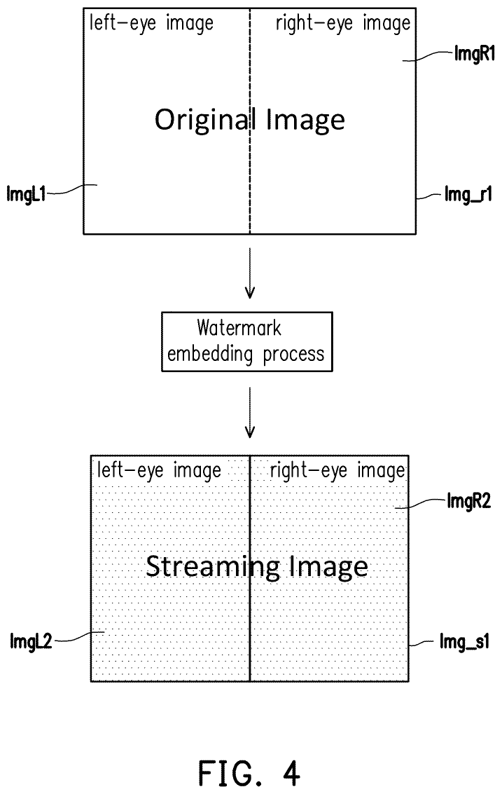

For example, FIG. 4 is a schematic diagram of embedding watermarks according to an embodiment of the disclosure. Referring to FIG. 4, the original image Imgr_1 conforming to the Side-by-Side image format has a left eye image ImgL1 and a right eye image ImgR1. After watermark embedding processing, an invisible watermark may be embedded in the original image Imgr_1 to generate a streaming image Imgs_1. The streaming image Imgs_1 includes a left eye image ImgL2 and a right eye image ImgR2. In some embodiments, the invisible watermark may be embedded through spatial domain embedding processing or frequency domain embedding processing. In some embodiments, the invisible watermark may be embedded through a deep learning network model. The aforementioned deep learning network model may be a Generative Adversarial Network (GAN) model, such as the Robust Invisible Video Watermarking with Attention-Guided Generative Adversarial Network (RivaGAN) model. Based on this, when the processor 140 receives the streaming image Imgs_1 through the transceiver 110 and generates a display frame including the streaming image Imgs_1, the processor 140 may identify the watermark in the display frame by executing watermark detection on a specific rectangular image region in the display frame.

Returning to FIG. 3, in step S320, by executing edge detection and straight line detection, the processor 140 may extract at least one rectangular image region from the display frame. Furthermore, the streaming image may be displayed within a certain rectangular image region in the display frame, therefore the processor 140 may first identify multiple rectangular image regions in the display frame. In other words, the processor 140 may search for the streaming image in the display frame through edge detection and straight line detection. In step S330, the processor 140 may execute a watermark detection on the at least one rectangular image region. That is, the processor 140 may sequentially perform watermark detection on each rectangular image region. In step S340, the processor 140 may determine whether the watermark appears in one of the at least one rectangular image region.

Specifically, the display frame obtained based on screen capture technology may include the streaming image and other image content (such as window operation interfaces, etc.), and image content unrelated to the existence of watermarks affects the accuracy and efficiency of watermark detection. Therefore, in the disclosed embodiment, the processor 140 may first identify one or more rectangular image region(s) in the display frame through edge detection and straight line detection, and the streaming image is displayed in one of these rectangular image regions. Subsequently, the processor 140 may execute watermark detection on these rectangular image regions, thereby determining whether the display frame includes a streaming image with a watermark and obtaining the location of the streaming image with the watermark.

In some embodiments, the processor 140 may detect a invisible watermark in at least one rectangular image region through a deep learning model. That is, the processor 140 may input each rectangular image region into a deep learning model, which may attempt to extract watermark from each rectangular image region. When the deep learning model cannot find any watermark in a certain rectangular image region, it may output a preset indicator or value representing the absence of a watermark. When the deep learning model can find a watermark in a certain rectangular image region, it may output the binary representation of the watermark's encoded information. The deep learning model, for example, may be a RivaGAN model, but is not limited thereto.

It is worth noting that, if the entire display frame is directly input into the deep learning model, even if the streaming image in the display frame has an embedded watermark, the processor 140 may not be able to correctly detect the existence of the watermark using the deep learning model. The reason is that the display frame may also include other image content unrelated to the streaming image, and these other image contents are also irrelevant to the deep learning model's watermark embedding process. Therefore, the deep learning model may not be able to correctly detect the existence of the watermark from the display frame. Consequently, the disclosure may improve the accuracy of watermark detection after identifying multiple rectangular image regions.

If step S340 determines yes, it represents that the streaming image conforms to the stereoscopic image format. In step S350, in response to a watermark appearing in at least one of the rectangular image regions, the processor 140 may generate a stereoscopic format image based on the display frame and at least one of the rectangular image regions. This stereoscopic format image is a side-by-side image including a first perspective image and a second perspective image. The first perspective image may be a left eye image, while the second perspective image may be a right eye image. Alternatively, the first perspective image may be a right eye image, while the second perspective image may be a left eye image.

In detail, since the user may resize or move the application window of the application, the size and position of the streaming image within the application window in the display frame are variable. In the disclosed embodiments, in response to the movement or resizing of the application window, the rectangular image region with the watermark may also correspondingly move and resize. Therefore, based on the range defined by the rectangular image region with the watermark, the processor 140 may obtain the image occupancy range of the streaming image conforming to the stereoscopic image format in the display frame.

Thus, the processor 140 may generate the left eye image and right eye image of the stereoscopic format image based on the two-dimensional background area in the display frame and the rectangular image region with the watermark. Specifically, the left eye image of the stereoscopic format image may include the two-dimensional background area in the display frame and the left eye image of the streaming image. The right eye image of the stereoscopic format image may include the two-dimensional background area in the display frame and the right eye image of the streaming image. In other words, the stereoscopic format image simultaneously includes 3D image content with parallax and two-dimensional background without parallax.

In step S360, the processor 140 may control the stereoscopic display 120 to operate in stereoscopic display mode to display the stereoscopic format image, so that the image content of the streaming image is presented with stereoscopic visual effect. Specifically, when the stereoscopic display 120 is a naked-eye stereoscopic display, the processor 140 may perform image weaving processing on the stereoscopic format image (for example, SBS image) to obtain an interwoven image. The image weaving processing arranges the pixels of the left eye image and the right eye image of the stereoscopic format image interleaved in the weaving frame. Subsequently, when the stereoscopic display 120 operates in stereoscopic display mode, the display panel 121 of the stereoscopic display 120 will display the interwoven image, and the refraction function of the lens layer 122 of the stereoscopic display 120 is enabled, allowing the viewer to perceive the stereoscopic visual effect.

For example, in the operation scenario where the processor 140 executes the video conferencing software, in response to the watermark appearing in a certain rectangular image region in the display frame, the stereoscopic display 120 may enable the stereoscopic display function, and display both the stereoscopic streaming content provided by the conference participant and the window operation interface of the video conferencing software. Therefore, the user may perceive the stereoscopic visual effect.

On the other hand, if the determination in step S340 is negative, it indicates that the streaming image does not conform to the stereoscopic image format. In step S370, in response to a watermark not appearing in at least one rectangular image region, the processor 140 controls the stereoscopic display 120 to operate in a two-dimensional display mode and display the display frame. In some embodiments, when the stereoscopic display 120, which is a naked-eye stereoscopic display, operates in two-dimensional display mode and does not provide stereoscopic display function, the display panel 121 of the stereoscopic display 120 will output the display frame, and the refraction function of the lens layer 122 of the stereoscopic display 120 is disabled.

For example, in the operation scenario where the processor 140 executes the video conferencing software, in response to the watermark not appearing in any rectangular image region of the display frame, the stereoscopic display 120 may disable the stereoscopic display function, and display the display frame including the streaming image and the window operation interface of the video conferencing software.

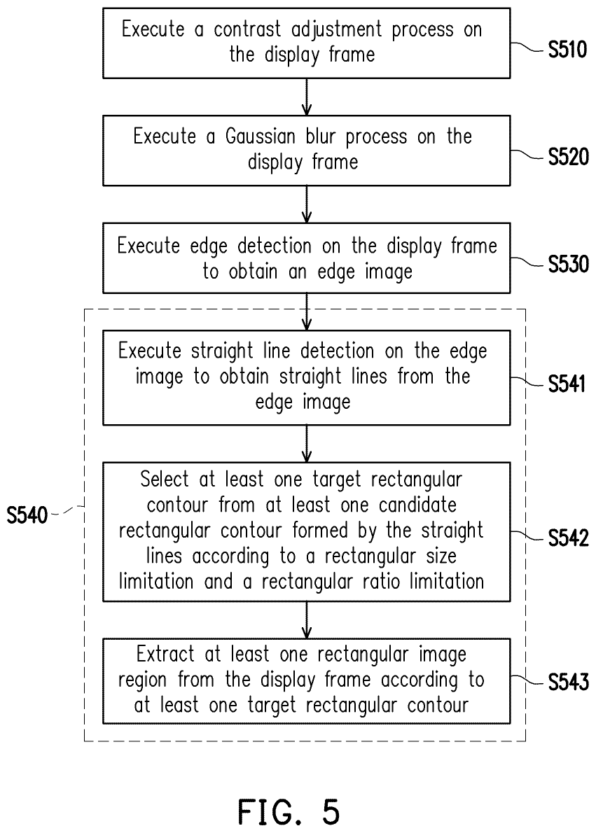

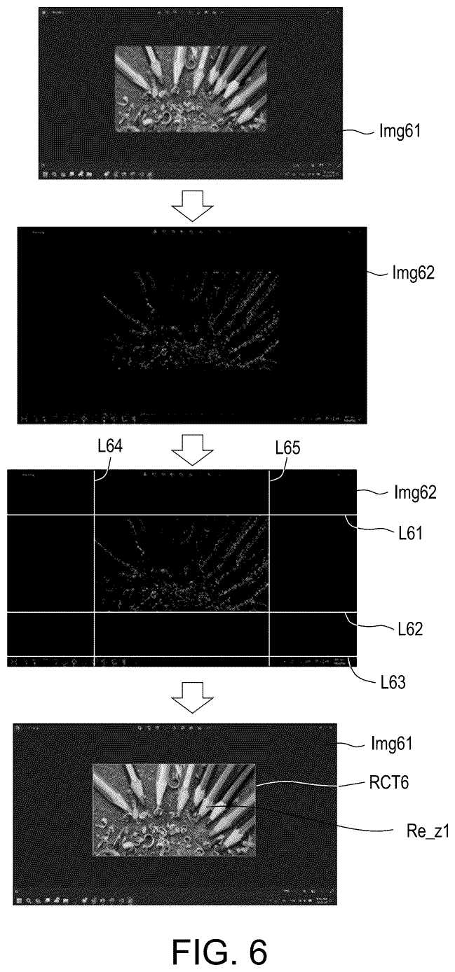

FIG. 5 is a flowchart of extracting at least one rectangular image region according to an embodiment of the disclosure. Referring to FIG. 5, the operation process of the embodiment is applicable to the electronic apparatus 100 in the aforementioned embodiment. The following will explain the detailed steps of the embodiment in conjunction with various components in the electronic apparatus 100. To clearly illustrate the principle of the embodiment, the following description will be supplemented with FIG. 6. FIG. 6 is a schematic diagram of extracting at least one rectangular image region according to an embodiment of the disclosure.

In step S510, the processor 140 may execute a contrast adjustment process on the display frame Img61. The processor 140 may increase the contrast of the display frame Img61, making the brightness differences between different areas in the display frame Img61 more pronounced, thereby making the edges in the display frame Img61 more prominent.

In step S520, the processor 140 may execute a Gaussian Blur process on the contrast-adjusted display frame Img61 to reduce noise and smooth edges.

In step S530, the processor 140 executes edge detection on the display frame Img61 that has undergone contrast adjustment and Gaussian Blur processing to obtain an edge image Img62. The edge image Img62 may be a binarized image composed of edge pixels. The edge detection, for example, may be Canny edge detection, but it is not limited thereto.

In step S540, the processor 140 may execute straight line detection on the edge image Img62, and extract at least one rectangular image region in the display frame Img61 according to the straight lines L61~L65. In an embodiment, step S540 may be implemented as steps S541 to S543.

In step S541, the processor 140 may execute the straight line detection on the edge image Img62 to obtain multiple straight lines L61~L65 from the edge image. In some embodiments, the straight lines L61~L65 include multiple vertical straight lines and multiple horizontal straight lines. In some embodiments, the processor 140 may execute the straight line detection based on a Hough transform procedure. The processor 140 may execute edge detection to obtain multiple edges in the edge image Img62, and keep at vertical straight lines and horizontal straight lines with lengths greater than a length threshold from these edges. However, regarding straight line detection, Hough transform procedures or other straight line detection algorithms familiar to those skilled in the art may be applied for embodiment, without specific limitations.

In step S542, the processor 140 may select at least one target rectangular contour RCT6 from at least one candidate rectangular contour formed by the straight lines, according to a rectangular size limitation and a rectangular ratio limitation. The processor 140 may determine whether the multiple straight lines L61~L65 can form a candidate rectangular contour. Furthermore, the processor 140 may identify at least one candidate rectangular contour formed by some of the straight lines based on the slope, intersection points, length, and other line information of the straight lines L61~L65. For example, the processor 140 may identify a candidate rectangular contour formed by straight lines L64, L65, L61, and L62. The processor 140 may identify another candidate rectangular contour formed by straight lines L64, L65, L63, and L62.

Next, the processor 140 may determine whether these candidate rectangular contours satisfy the rectangular size limitation. For example, the processor 140 may determine whether the area of these candidate rectangular contours is greater than a lower limit of rectangular area. The processor 140 may determine whether the area of these candidate rectangular contours is less than an upper limit of rectangular area. Alternatively, the processor 140 may determine whether these candidate rectangular contours satisfy the rectangular ratio limitation. For example, the processor 140 may determine whether the width-to-height ratio of these candidate rectangular contours is within a preset range. Based on this, through filtering with the rectangular size limitation and the rectangular ratio limitation, the processor 140 may keep at least one target rectangular contour RCT6 from at least one candidate rectangular contour.

In step S543, the processor 140 may extract at least one rectangular image region Re_z1 from the display frame Img61 according to at least one target rectangular contour RCT6. However, FIG. 6 is only used to demonstrate and illustrate the detection principle of rectangular image regions. The number and position of straight lines, as well as the number and position of rectangular image regions, depend on the actual content of the display frame.

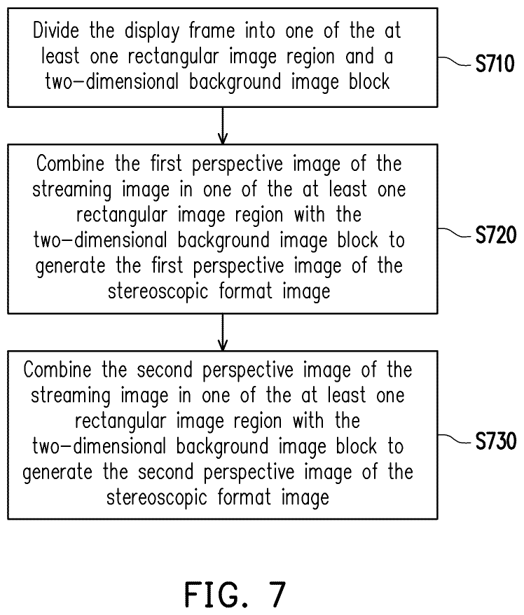

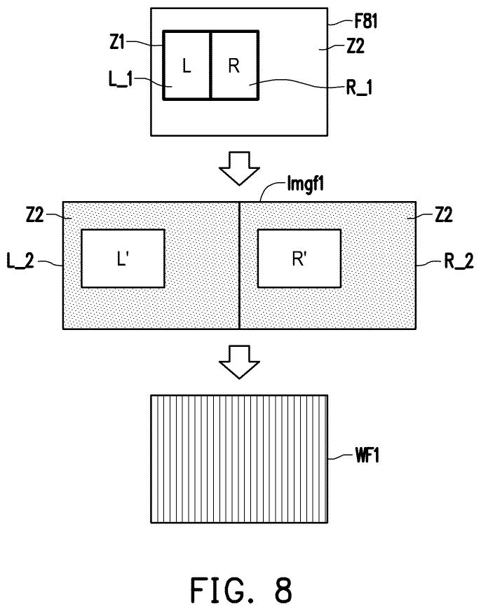

FIG. 7 is a flowchart of generating a stereoscopic format image according to an embodiment of the disclosure. Referring to FIG. 7, the operation process of the embodiment is applicable to the electronic apparatus 100 in the aforementioned embodiment. The following will explain the detailed steps of the embodiment in conjunction with various components in the electronic apparatus 100. To clearly illustrate the principle of the embodiment, the following descriptions will be supplemented with FIG. 8. FIG. 8 is a schematic diagram of generating a stereoscopic format image and interlacing frames according to an embodiment of the disclosure. Please refer to FIG. 7 and FIG. 8 together.

In step S710, the processor 140 may divide the display frame F81 into at least one rectangular image region, one of which is rectangular image region Z1, and a two-dimensional background image block Z2. In other words, after the processor 140 detects the presence of a watermark from the rectangular image region Z1, the processor 140 divides the display frame F81 into the rectangular image region Z1 with the watermark and the two-dimensional background image block Z2. The rectangular image region Z1 includes the streaming image that conforms to the stereoscopic image format and includes a first perspective image L_1 (i.e., left eye image) and a second perspective image R_1 (i.e., right eye image).

In step S720, the processor 140 may combine the first perspective image L_1 of the streaming image in one of the at least one rectangular image region (i.e., rectangular image region Z1) with the two-dimensional background image block Z2 to generate the first perspective image L_2 of the stereoscopic format image Imgf1. The at least one rectangular image region (i.e., rectangular image region Z1) includes the streaming image that conforms to the stereoscopic image format. Specifically, the processor 140 may perform image scaling processing on the first perspective image L_1 of the streaming images according to the display block size of the rectangular image region Z1. The processor 140 may generate the first perspective image L_2 by combining the scaled first perspective image L_1 with the two-dimensional background image block Z2 according to the display position of the rectangular image region Z1.

In step S730, the processor 140 may combine the second perspective image R_1 of the streaming images in one of the at least one rectangular image region (i.e., rectangular image region Z1) with the two-dimensional background image block Z2 to generate the second perspective image R_2 of the stereoscopic format image Imgf1. The method of generating the second perspective image R_2 is the same as the method of generating the first perspective image L_2, which will not be repeated here.

In some embodiments, when the stereoscopic display 120 is a naked-eye stereoscopic display, the processor 140 may perform image weaving processing on the stereoscopic format image Imgfl to generate an weaving frame WF1. In this case, when the stereoscopic display 120 displays the weaving frame WF1, the viewer may see stereoscopic streaming content with stereoscopic visual effects.

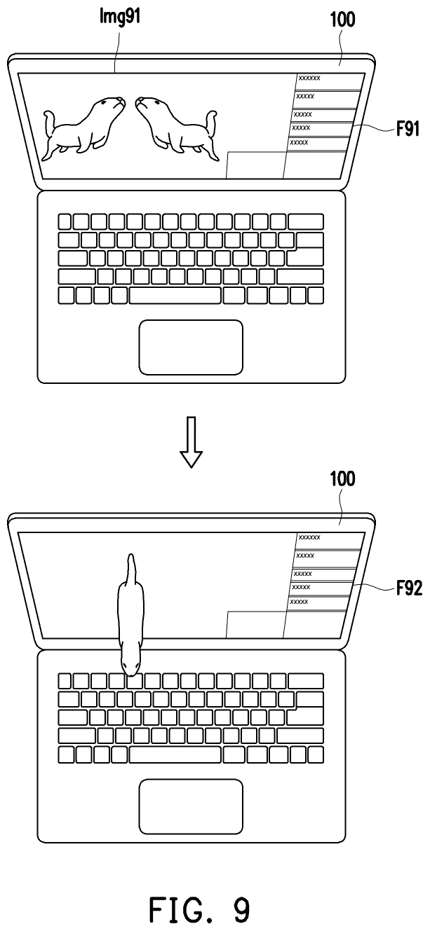

FIG. 9 is a schematic diagram illustrating a scenario where the image content of streaming images is presented with stereoscopic visual effects according to an embodiment of the disclosure. Referring to FIG. 9, the electronic apparatus 100 may execute a conferencing software program to display a display frame F91. The display frame F91 includes a streaming image Img91 and a window operation interface, and the streaming image Img91 conforming to the SBS format is embedded with a watermark. Thus, after detecting that the streaming image Img91 has a watermark, the electronic apparatus 100 may switch to a stereoscopic display mode to display the display frame F92, so that the image content of the streaming image Img91 is presented with stereoscopic visual effects.

In summary, in the embodiments of the disclosure, if a watermark appears in a rectangular image region of a display frame, it may be determined that the display frame includes stereoscopic streaming images conforming to a stereoscopic image format. Moreover, the image range of the streaming images conforming to the stereoscopic image format may be determined based on the rectangular image region where the watermark is detected, to distinguish the 3D content image region from the two-dimensional background region in the display frame. Subsequently, the display frame may be converted into a stereoscopic format image including left eye image and right eye image, and the stereoscopic display may be controlled to operate in a stereoscopic display mode to display the stereoscopic format image. Based on this, by embedding a watermark in the stereoscopic format image, it is possible to accurately detect that the display frame includes streaming images conforming to the stereoscopic image format, in order to control the stereoscopic display to automatically provide stereoscopic display function. Furthermore, since watermark detection is performed on each rectangular image region, the accuracy and efficiency of watermark detection may be improved.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

1. A stereoscopic image display method, adapted to an electronic apparatus comprising a stereoscopic display, and comprising:
obtaining a display frame comprising a streaming image;
extracting at least one rectangular image region in the display frame by executing edge detection and straight line detection;
executing a watermark detection to detect whether a watermark appears in the at least one rectangular image region, wherein the watermark is configured to indicate that the streaming image within one of the at least one rectangular image region conforms to a stereoscopic image format;
in response to the watermark appearing in a certain rectangular image region of the at least one rectangular image region, generating a stereoscopic format image according to the display frame and the certain rectangular image region comprises:
dividing the display frame into the certain rectangular image region with the watermark and a two-dimensional background image block which is non-overlapped with the certain rectangular image region, wherein the certain rectangular image region comprises the streaming image conforming to a stereoscopic image format, and the streaming image comprises a first perspective image and a second perspective image;
combining the first perspective image of the streaming image in the certain rectangular image region with the two-dimensional background image block as a first perspective image of the stereoscopic format image; and
combining the second perspective image of the streaming image in the certain rectangular image region with the two-dimensional background image block as a second perspective image of the stereoscopic format image; and
controlling the stereoscopic display to operate in a stereoscopic display mode to display the stereoscopic format image, to present image content of the streaming image with stereoscopic visual effect.

2. The stereoscopic image display method as claimed in claim 1, further comprising:
in response to the watermark not appearing in the at least one rectangular image region, controlling the stereoscopic display to operate in a two-dimensional display mode to display the display frame.

3. The stereoscopic image display method as claimed in claim 1, wherein the step of extracting the at least one rectangular image region in the display frame by executing the edge detection and the straight line detection comprises:
executing the edge detection on the display frame to obtain an edge image; and
executing the straight line detection on the edge image to extract the at least one rectangular image region in the display frame according to a plurality of straight lines.

4. The stereoscopic image display method as claimed in claim 3, wherein the step of executing the straight line detection on the edge image to extract the at least one rectangular image region in the display frame according to the plurality of straight lines comprises:
executing the straight line detection on the edge image to obtain the plurality of straight lines from the edge image;
selecting at least one target rectangular contour from at least one candidate rectangular contour formed by the plurality of straight lines according to a rectangular size limit and a rectangular ratio limit; and
extracting the at least one rectangular image region from the display frame according to the at least one target rectangular contour.

5. The stereoscopic image display method as claimed in claim 4, wherein the plurality of straight lines comprise a plurality of vertical straight lines and a plurality of horizontal straight lines.

6. The stereoscopic image display method as claimed in claim 3, wherein before the step of executing the edge detection on the display frame to obtain the edge image, the method further comprises:
executing a contrast adjustment process on the display frame; and
executing a Gaussian blur process on the display frame.

7. (canceled)

8. The stereoscopic image display method as claimed in claim 7, wherein the stereoscopic image format comprises a side-by-side format.

9. The stereoscopic image display method as claimed in claim 1, wherein the step of obtaining the display frame comprising the streaming image comprises:
extracting the display frame comprising the streaming image by using a screenshot function.

10. The stereoscopic image display method as claimed in claim 1, wherein the step of executing the watermark detection on the at least one rectangular image region comprises:
detecting an invisible watermark in the at least one rectangular image region through a deep learning model.

11. An electronic apparatus, comprising:
a transceiver, configured to receive a streaming image;
a stereoscopic display; and
at least one processor, coupled to the transceiver and the stereoscopic display, and configured to:
obtain a display frame comprising a streaming image;
extract at least one rectangular image region in the display frame by executing edge detection and straight line detection;
executing a watermark detection to detect whether a watermark appears in the at least one rectangular image region, wherein the watermark is configure to indicate that the streaming image within one of the at least one rectangular image region conforms to a stereoscopic image format;
in response to the watermark appearing in a certain rectangular image region of the at least one rectangular image region, generate a stereoscopic format image according to the display frame and the certain rectangular image region comprises:
dividing the display frame into the certain rectangular image region with the watermark and a two-dimensional background image block which is non-overlapped with the certain rectangular image region, wherein the certain rectangular image region comprises the streaming image conforming to a stereoscopic image format, and the streaming image comprises a first perspective image and a second perspective image;
combining the first perspective image of the streaming image in the certain rectangular image region with the two-dimensional background image block as a first perspective image of the stereoscopic format image; and
combining the second perspective image of the streaming image in the certain rectangular image region with the two-dimensional background image block as a second perspective image of the stereoscopic format image; and
control the stereoscopic display to operate in a stereoscopic display mode to display the stereoscopic format image, to present image content of the streaming image with stereoscopic visual effect.
